(19) United States
(12) Patent Application Publication
(10) Pub. No.: US 2011/0182457 A1
(43) Pub. Date: Jul. 28, 2011

(54) IN-EAR EARPHONE WITH CAPACITIVE SENSING FUNCTION

(76) Inventors: Chiu-Yun Tung, Taichung City (TW); Hui-Yin Liang, Taichung City (TW); Ju-Mei Tsai, Taichung City (TW); Yu-Huan Yen, Taichung City (TW); Chien-Cheng Yang, Taichung City (TW); Ming-Hung Tsai, Taichung City (TW); Shi-Pan Ho, Taichung City (TW)

(21) Appl. No.: 12/973,036

(22) Filed: Dec. 20, 2010

(30) Foreign Application Priority Data
Jan. 28, 2010 (TW) 099102362

(51) Int. Cl. H04R 1/10

(52) U.S. Cl. 381/380

(57) ABSTRACT

An in-ear earphone with a capacitive sensing function is provided. The earphone includes a case, a speaker, a circuit board, and a capacitive sensing unit. The case has an extension tube and an accommodating portion. An ear tip is sleeved on the extension tube. The accommodating portion accommodates the speaker, the circuit board, and the capacitive sensing unit. A sound emitting surface of the speaker faces the extension tube. The circuit board is electrically connected to the speaker, and a sensing chip is disposed on the circuit board. The capacitive sensing unit includes a sensor and a conducting element. The sensor is electrically connected to the sensing chip through the conducting element. When the extension tube is inserted into an ear canal of a user, the sensor returns a sensing signal to the sensing chip, and the sensing chip sends a control signal to control sound output of the speaker.

### CROSS-REFERENCE TO RELATED APPLICATION

This application claims the benefit of Taiwan Patent Application No. 099102362, filed on Jan. 28, 2010, which is hereby incorporated by reference for all purposes as if fully set forth herein.

### BACKGROUND OF THE INVENTION

1. Field of Invention

The present invention relates to an in-ear earphone, and more particularly to an in-ear earphone applicable to control sound on/off or switching on the basis of capacitive sensing.

2. Related Art

With the digital development of music files, new music players are also proposed continuously, and most of which require earphones to send music signals to ears of users. However, when a user intends to control playback, pause, or song selection functions, the user must pick up the music player such as an MP3 player, and select the functions by pressing buttons of the music player. Or, when the earphone is used together with a mobile phone, besides the function of controlling to pause the music playback, call functions such as answering or hanging up a call must be added. Therefore, such functional keys are mostly designed on the MP3 players or mobile phones.

Nowadays, many music fans or business professionals are used to listening to music or answering phone calls while walking, riding, or driving. However, it may disturb the user or even cause an accident to move on a busy street while picking up the MP3 player or mobile phone to press the music or call control buttons at the same time. Even in an advanced earphone, a control box is often designed between the earphone and the MP3 player or mobile phone, such that the user can control the MP3 player or mobile phone without taking it out, and can execute music playback functions or call functions by directly pressing the operating buttons on the control box. However, due to being limited by the size of the control box, the buttons are often not large enough for being touched and operated conveniently, so that the user may still be disturbed when performing the control. Therefore, the conventional earphone and the control mode thereof still need to be improved.

### SUMMARY OF THE INVENTION

In view of the above, the present invention is directed to an in-ear earphone, which performs music playback or determines whether to perform a call function according to a capacitive sensing result.

To achieve the above objective, the present invention provides an in-ear earphone with a capacitive sensing function, which includes a case, a speaker, a circuit board, and a capacitive sensing unit. The case has an accommodating portion and an extension tube. An ear tip is sleeved on the extension tube. The accommodating portion accommodates the speaker, the circuit board, and the capacitive sensing unit. A sound emitting surface of the speaker faces the extension tube. The circuit board is electrically connected to the speaker, and a sensing chip is disposed on the circuit board. The capacitive sensing unit includes a sensor and a conducting element. The sensor is electrically connected to the sensing chip through the conducting element. When the extension tube of the case is inserted into an ear canal of the user, the sensor returns a sensing signal to the sensing chip through the conducting element, and the sensing chip sends a control signal according to a capacitance change of the sensing signal, so as to control sound output of the speaker.

Based on the above, in the in-ear earphone with a capacitive sensing function of the present invention, a sensor is disposed at an appropriate position on an inner periphery or outer periphery of the case, and is used for sensing the capacitance change of the human body, so as to generate a sensing signal, and a corresponding control signal is generated according to the sensing signal to control the sound output of the speaker. Therefore, according to a preset operation mode, a music signal or voice signal can be executed, turned off, or switched while the user wears or takes out the earphone, so as to prevent the risk generated because the user is disturbed when operating a conventional earphone using the hand, and enhance the pleasure in operating and controlling the earphone.

### BRIEF DESCRIPTION OF THE DRAWINGS

FIG. 1 is a cross-sectional view of a first embodiment of the present invention;

FIG. 2 is a cross-sectional view of a second embodiment of the present invention;

FIG. 3 is a cross-sectional view of a third embodiment of the present invention;

FIG. 4 is a cross-sectional view of a fourth embodiment of the present invention;

FIG. 5 is a cross-sectional view of a fifth embodiment of the present invention; and

FIG. 6 is a cross-sectional view of a sixth embodiment of the present invention.

### DETAILED DESCRIPTION OF THE INVENTION

The in-ear earphone with a capacitive sensing function according to the embodiments of the present invention is illustrated below with reference to the accompanying drawings.

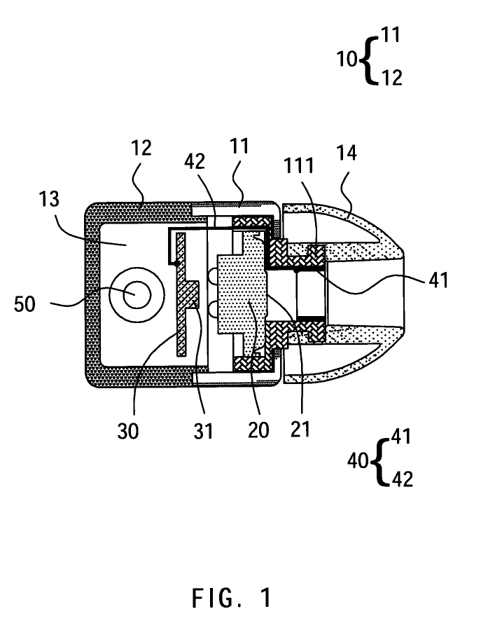

FIG. 1 is a cross-sectional view of an in-ear earphone with a capacitive sensing function according to a first embodiment of the present invention. Referring to FIG. 1, the in-ear earphone of the present invention includes a case 10. The case 10 has a front case 11 and a rear case 12. An extension tube 111 extends from a front end of the front case 11, and a back end of the front case 11 is combined with the rear case 12 to form an accommodating portion 13. An ear tip 14 is sleeved on the extension tube 111. A speaker 20, a circuit board 30, and a capacitive sensing unit 40 are disposed in the accommodating portion 13.

The speaker 20 is disposed between the circuit board 30 and the extension tube 111, and has a sound emitting surface 21 facing a direction of the extension tube 111, such that a sound emitted by the speaker 20 is directly transferred to an ear canal of the user through the extension tube 111.

The circuit board 30 is disposed at a back end of the speaker 20, and is electrically connected to the speaker 20. A sensing chip 31 and a plurality of passive elements (not shown) are disposed on the circuit board 30. The sensing chip 31 and the passive elements process electronic signals, so as to control a sound output performance of the speaker 20.

The capacitive sensing unit 40 includes a sensor 41 and a conducting element 42. In this embodiment, the sensor 41 is implemented as a copper ring disposed at an inner periphery of the extension tube 111 of the case 10, and the conducting element 42 is implemented as a wire, and is electrically connected to the sensor 41 and the circuit board 30, such that the sensor 41 is enabled to return a sensing signal to the sensing chip 31. Thus, the circuit board 30 generates a control signal according to the capacitance change sensed by the sensor 41, so as to control sound output of the speaker 20.

Furthermore, the in-ear earphone of the present invention further includes a signal wire 50 wrapped by a plastic material. The signal wire 50 is electrically connected to the circuit board 30 and a sound generating device such as an MP3 player or a mobile phone, so as to transmit a music or voice signal of the MP3 player or mobile phone to the circuit board 30. The circuit board 30 controls whether to transmit the music or voice signal to the speaker 20 by determining the sensing signal returned from the sensor 41.

In addition, the in-ear earphone of the present invention may further include a control box between the case 10 and the sound generating device. A central processing unit (CPU) is disposed in the control box, so as to receive the sensing signal and provide more complicated music or voice signal processing according to the sensing signal.

The in-ear earphone with a capacitive sensing function of the present invention determines whether the earphone is put into the ear canal of the user to generate the capacitance change by using the sensor 41, and generates a sensing signal to the sensing chip 31 according to the determination result, such that the circuit board 30 generates a control signal according to the capacitance change. For example, if the user has something to deal with immediately when listening to music, the user only needs to take out the earphone, so that the sensing chip 31 can read the capacitance change. At this time, the control signal can enable the speaker to stop playing the music, so as to save the power. Moreover, if the user has an incoming call when the user is listening to music, the user may take out the earphone and then put the earphone back into the ear canal, and the two capacitance changes are regarded as a control signal, so as to enable the speaker 20 to switch from the original music signal to a voice signal immediately. Thus, the output signal may be changed through the simple action of taking out and wearing the earphone, and the user is not disturbed by searching the buttons on a sound generating device or control box any more, so that the risk of accidents is reduced significantly.

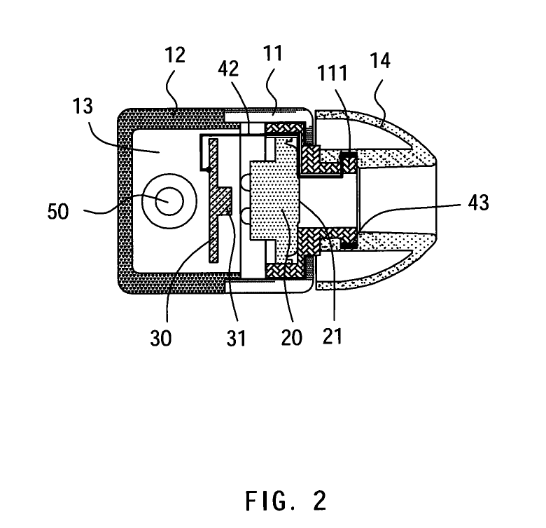

FIG. 2 is a cross-sectional view of an in-ear earphone with a capacitive sensing function according to a second embodiment of the present invention. This embodiment has substantially the same structure as the above embodiment, so that the same structural components are indicated by the same reference numerals, and the functions and positions thereof will not be described again here.

The difference between this embodiment and the first embodiment is that, the sensor 41 is implemented as a copper ring disposed at the inner periphery of the extension tube 111 in the first embodiment, whereas a sensor 43 is implemented as a copper ring disposed at an outer periphery of the extension tube 111 in this embodiment. That is, the copper ring is clamped between the extension tube 111 and the ear tip 14 in this embodiment, such that the copper ring is protected from being influenced by moisture or dust, thereby having longer service life or higher sensing precision performance.

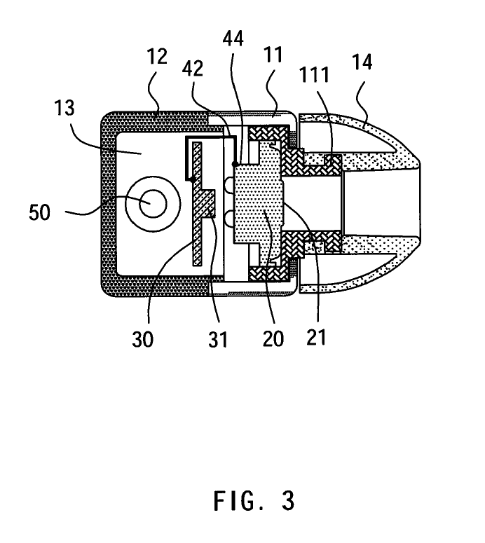

FIG. 3 is a cross-sectional view of an in-ear earphone with a capacitive sensing function according to a third embodiment of the present invention. This embodiment has substantially the same structure as the above embodiments, so that the same structural components are indicated by the same reference numerals, and the functions and positions thereof will not be described again here.

The difference between this embodiment and the above embodiments is that, a sensor 44 is implemented as a metal piece disposed on the speaker 20 in this embodiment, so that a sensing signal is directly transmitted to the sensing chip 31 according to the sensed capacitance change on the speaker 20. In this embodiment, the speaker 20 is directly taken as the sensor, and the copper ring is omitted in this embodiment as compared with the above two embodiments, which can reduce the manufacturing cost of the earphone.

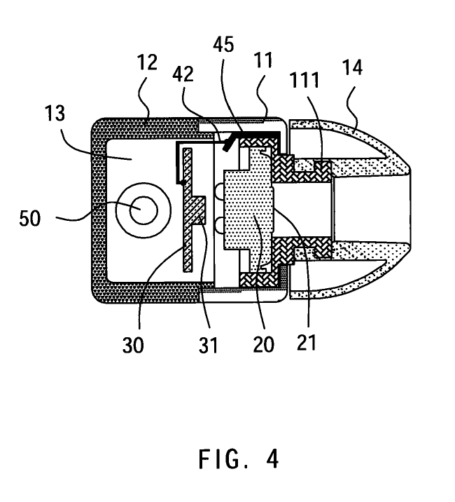

FIG. 4 is a cross-sectional view of an in-ear earphone with a capacitive sensing function according to a fourth embodiment of the present invention. This embodiment has substantially the same structure as the above embodiments, so that the same structural components are indicated by the same reference numerals, and the functions and positions thereof will not be described again here.

The difference between this embodiment and the above embodiments is that, a sensor 45 is implemented as a copper foil in this embodiment, and the copper foil is disposed in a region between the front case 11 and the extension tube 111. Therefore, the copper foil serves as the component for capacitive sensing in this embodiment, thereby avoiding contacting the moisture or dust.

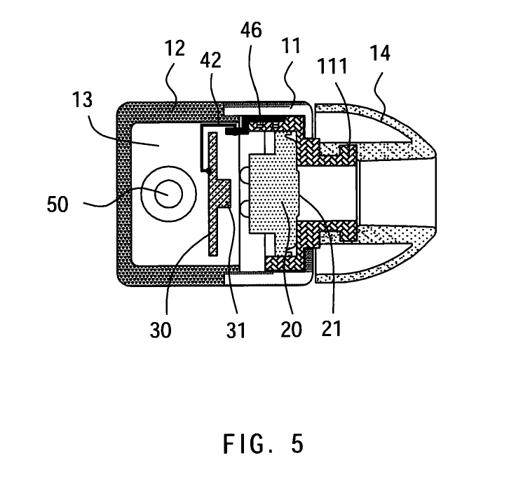

FIG. 5 is a cross-sectional view of an in-ear earphone with a capacitive sensing function according to a fifth embodiment of the present invention. This embodiment has substantially the same structure as the above embodiments, so that the same structural components are indicated by the same reference numerals, and the functions and positions thereof will not be described again here.

The difference between this embodiment and the fourth embodiment is that, a sensor 46 is implemented as a metal terminal in this embodiment, and the metal terminal is disposed in a region between the front case 11 and the extension tube 111. Therefore, the metal terminal serves as the component for capacitive sensing in this embodiment, thereby avoiding contacting the moisture or dust.

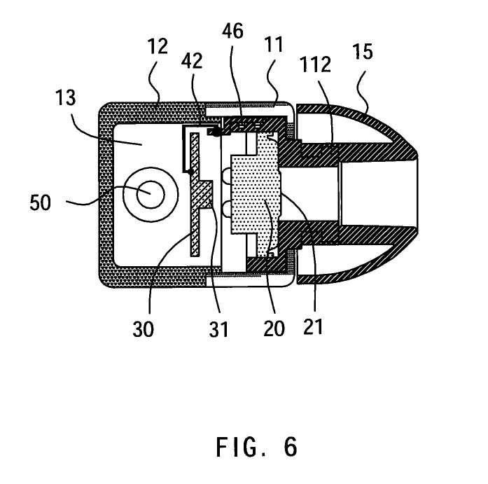

FIG. 6 is a cross-sectional view of an in-ear earphone with a capacitive sensing function according to a sixth embodiment of the present invention. This embodiment has substantially the same structure as the above embodiments, so that the same structural components are indicated by the same reference numerals, and the functions and positions thereof will not be described again here.

The difference between this embodiment and the fifth embodiment is that, an ear tip 15 and an extension tube 112 are made of a conductive material or coated by a conductive material in this embodiment, and the ear tip 15, the extension tube 112, and a sensor 46 are electrically connected. Thus, once the ear tip 15 is made to contact the human body, the sensor 46 senses the capacitance change, and immediately generates a sensing signal to the sensing chip, so as to perform output control on the speaker 20. Therefore, the ear tip 15 directly performs contact sensing in this embodiment, which has a better sensing performance, and achieves a sensing effect better than that of the above embodiments.

In addition, the ear tip 15 and the extension tube 112 are made of a conductive material or coated by a conductive material, so that the ear tip 15 and the extension tube 112 can be used to replace the sensor 46 for sensing the capacitance change directly.

As described above, in the in-ear earphone with a capacitive sensing function of the present invention, the sensor is disposed at an appropriate position on an inner periphery or outer periphery of the case to determine whether the earphone is put into the ear canal of the user, the sensed capacitance change is transmitted to the sensing chip integrated in the case, and a corresponding control signal is generated to control the sound output of the speaker. Therefore, according to the preset sensing signal and the corresponding control signal, a music signal or voice signal can be executed, turned off, or switched while the user wears or takes out the earphone, so as to prevent the risk generated because the user is disturbed when operating the buttons, and enhance the pleasure in operating the earphone.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An in-ear earphone with a capacitive sensing function, comprising:
a case, having an accommodating portion and an extension tube, wherein an ear tip is sleeved on the extension tube;
a speaker, disposed in the accommodating portion, wherein a sound emitting surface of the speaker faces the extension tube;
a circuit board, disposed in the accommodating portion, and electrically connected to the speaker, wherein a sensing chip is disposed on the circuit board; and
a capacitive sensing unit, comprising a sensor and a conducting element, wherein the sensor is disposed in the case, and is electrically connected to the sensing chip through the conducting element;
wherein when the extension tube of the case is inserted into an ear canal of a user, the sensor returns a sensing signal to the sensing chip through the conducting element, and the sensing chip sends a control signal according to a capacitance change of the sensing signal, so as to control an operation of the speaker.

2. The in-ear earphone with a capacitive sensing function according to claim 1, wherein the case has a front case and a rear case, the extension tube extends from a front end of the front case, and a back end of the front case is combined with the rear case to form the accommodating portion.

3. The in-ear earphone with a capacitive sensing function according to claim 2, wherein a signal wire is electrically connected to the circuit board and the signal wire is electrically connected to an electronic device after passing through the rear case.

4. The in-ear earphone with a capacitive sensing function according to claim 1, wherein the conducting element is a wire.

5. The in-ear earphone with a capacitive sensing function according to claim 1, wherein the sensor is a copper ring and the copper ring is disposed at an inner periphery of the extension tube.

6. The in-ear earphone with a capacitive sensing function according to claim 1, wherein the sensor is a copper ring and the copper ring is disposed on an outer periphery of the extension tube.

7. The in-ear earphone with a capacitive sensing function according to claim 1, wherein the sensor is a metal piece on the speaker.

8. The in-ear earphone with a capacitive sensing function according to claim 1, wherein the sensor is a copper foil and the copper foil is disposed on an inner periphery of the case.

9. The in-ear earphone with a capacitive sensing function according to claim 1, wherein the sensor is a metal terminal and the metal terminal is disposed on an inner periphery of the case.

10. The in-ear earphone with a capacitive sensing function according to claim 1, wherein the ear tip and the extension tube are made of a conductive material, and the ear tip, the extension tube, and the sensor are electrically connected.

11. The in-ear earphone with a capacitive sensing function according to claim 1, wherein the ear tip and the extension tube are made of a conductive material, and the sensor is formed by the ear tip and the extension tube.

12. The in-ear earphone with a capacitive sensing function according, to claim 1, wherein the ear tip and the extension tube are coated by a conductive material, and the ear tip, the extension tube, and the sensor are electrically connected.

13. The in-ear earphone with a capacitive sensing function according to claim 1, wherein the ear tip and the extension tube are coated by a conductive material, and the sensor is formed by the ear tip and the extension tube.
